(19) United States
(12) Patent Application Publication
(10) Pub. No.: US 2002/0143786 A1
(43) Pub. Date: Oct. 3, 2002

(54) User scope-based data organization system

(76) Inventors: Akin Ayi, Nashua, NH (US); Pete Cruz, Derry, NH (US); Roger Dev, Durham, NH (US); Eric Rustici, Londonderry, NH (US); Vick Vaishanavi, Danville, NH (US)

Correspondence Address: NUTTER MCCLENNEN & FISH LLP, WORLD TRADE CENTER WEST, 155 SEAPORT BOULEVARD, BOSTON, MA, 02110-2604, US

(21) Appl. No.: 09/822,769

(22) Filed: Mar. 30, 2001

(51) Int. Cl. G06F 7/00

(52) U.S. Cl. 707/102

(57) ABSTRACT

The present invention provides methods and system for organizing a dataset in a database by marking the dataset by a plurality of labels generated based on a pre-define policy. The policy determines the data scope accessible to each label. A user of the database can access the data within the scopes of one or more labels based on its role and privileges granted thereto by, for example, a system administrator. Moreover, a variety of shaping transformations can be applied to the tagged dataset to create a derived dataset that is suitable for the informational needs of the user. The derived dataset can be formatted to render it compatible for viewing via a selected presentation engine, such as a web browser.

### BACKGROUND OF THE INVENTION

The present invention relates generally to providing methods and system for organizing data in a database, and more particularly, for organizing the data in accordance with the informational needs of users of the database.

The management of large complex systems such as computer networks, power plants, transportation systems and military operations requires cooperation of many individuals acting in various roles and having responsibility for various subsets of the system. Each individual needs access to certain aspects of information about the system in order to be able to discharge his/her responsibility. System information is typically collected and maintained by various management information systems. The collected system data, however, is usually too large and too complex to be effectively utilized by an individual. Further, an individual may need access to only a subset of the entire data. In addition, the format of the collected raw data is typically not amenable to effective presentation to a user.

Accordingly, a need exists for providing methods and system for organizing data such that it can be efficiently utilized by individuals having different informational needs.

Further, a need exists for presenting information to such individuals in a manner that allows effective use of the information.

### SUMMARY OF THE INVENTION

The present invention provides methods and system for organizing information in a dataset contained, for example, in a database system. In one aspect, a method of the invention calls for defining a set of rules that establish a policy, and generating one or more labels based on the defined policy for marking, e.g., tagging, the dataset. The defined policy determines the data scope that is accessible to each label.

The policy can be defined based on various criteria that can include, but are not limited to, structure of an organization, geography, location of selected entities, names of selected entities, or interrelationships among selected entities. For example, in the network management domain, a policy can define a range of IP (internet protocol) addresses. Alternatively, a policy may define the telecommunications switches of a telephone service provider which are located within a particular locality, e.g., state, county, city.

In some embodiments, the dataset can include a plurality of fields and the rules of a policy can be defined as expressions, e.g., regular, Boolean, operating on selected fields of the dataset. Further, a policy may require matching a pre-defined pattern, e.g., address, location, or name, with selected fields of the dataset. Alternatively, a policy may require a calculation to determine whether a data element, e.g., field, is within the scope of the policy. For example, in the network management domain, a network path calculation may be utilized to determine which network elements support a particular application, e.g., electronic mail. The method of the invention also allows exceptions to general rules of policy to be defined to attain fine grain control of the dataset.

In one aspect, the labels generated for tagging the dataset are interrelated according to a selected topology. Such a topology can assume, for example, a distributed configuration or a hierarchy, such as a tree structure. Each label in a hierarchy can provide an entry point into the hierarchy, and a role of a user of the database can determine its entry point into the hierarchy. In other words, a role of the user can determine the labels, and consequently the data associated with those labels, to which the user has access. In some embodiments, a combination of a user's role and permission granted to the user determine the labels and/or the portions of data associated with the labels that are available to the user.

In a related aspect, the data scope of a label can be independent of the scopes of the other labels. Further, the data scope of a label within a hierarchy can be independent of the hierarchy and be only related to the role of a user having access to that label. For example, the data scope of a label in a label hierarchy can be more extensive than the data scope of another label that is higher in the hierarchy.

In another aspect, the method of the invention calls for transforming the data within the data scope of a label accessible to a user to create a derived data set, e.g., a subset of the data, that is suited to the informational needs of that user. Such a transformation can include, but is not limited to, summarization, statistical analysis, filtering, projection, or any other manipulation that transforms the information into a useful form for a targeted role, i.e., for a user having a particular role. For example, a temporal transformation can aggregate selected fields within a data scope of a label over a specified time period. The transformation preferably preserves the association of the derived data set with the label from which it was derived. This advantageously allows performing efficiently any number of iterative transformations.

In a related aspect, the derived data set can be formatted to augment it with information needed for a selected presentation format. A formatting transformation does not alter the information content of the derived data set, but adds information needed by various presentation engines for presenting, e.g., displaying, the data to a user. A presentation format can include, for example, hypertext mark-up language (HTML), extended mark-up language (XML), portable document format (PDF), comma-separated values (CSV), or relational database management system (RDBMS).

The methods of the invention can find a variety of applications. In particular, it is well suited for organizing data received by a network management system. In such a case, a policy related to the management of the network can be formulated, and the received data can be labeled based on the formulated policy in accord with the teachings of the invention. The policy can relate to, for example, the switches of an internet service provider (ISP) which support a particular customer of the ISP.

In a related aspect, a system for implementing a method of the invention can include a scope transform module that is in communication with a database. The scope transform module receives raw data from the database and adds labels to, i.e., marks, at least a portion of the raw data based on a pre-defined policy. The system can also include a shaping transform module that receives the labeled data and transforms at least a portion thereof to create a derived dataset that conforms to the informational needs of a user.

A format transform module receives the derived dataset and augments it with information needed for a selected presentation format, such as HTML, XML, PDF. A variety of presentation engines can be utilized to present the formatted data to a user. For example, one embodiment employs a web browser to present the derived dataset, which has been formatted in a web presentation format, e.g., HTML.

### BRIEF DESCRIPTION OF THE DRAWINGS

FIG. 1 is a flow chart depicting various steps of an exemplary embodiment of a method according to the invention for organizing data in a database,

FIG. 2 illustrates a sample policy defined in accord with the teachings of the invention,

FIG. 3 illustrates a sample label file created in accord with the teachings of the invention,

FIG. 4 schematically depicts an exemplary label hierarchy generated in accord with the teachings of the invention,

FIG. 5 is an exemplary user access list in accord with the teachings of the invention,

FIG. 6 is a diagram depicting various transformations applied to raw data present in a dataset in an exemplary embodiment of the invention,

FIG. 7 illustrates a sample policy file in accord with the teachings of the invention,

FIG. 8 is a diagram depicting an exemplary system for implementing a method for organizing data in accord with the teachings of the invention, and

FIG. 9 is a flow chart depicting various steps that an exemplary shaping transform module of a system of the invention can perform for creating a derived dataset.

### DETAILED DESCRIPTION

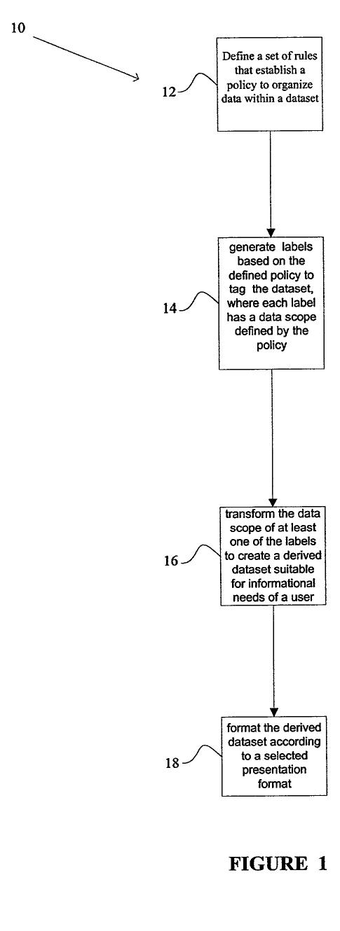

The present invention provides methods and system for organizing data in a database. FIG. 1 illustrates a flow chart 10 which depicts various steps for implementing an exemplary embodiment of the method of the invention. In step 12, a set of rules are defined for establishing a policy. A policy can be defined based on a variety of criteria which include, but are not limited to, the structure of an organization, geography, the location of selected entities, e.g., devices in a network of computers, the names of selected entities, and/or interrelationships among selected entities. As discussed in more detail below, a policy can be defined based on pattern matching, where the pattern can be, for example, a particular range, a regular expression, or a wild card. Alternatively, a calculation on a set of dependencies of a data element, e.g., a data field, can be performed to determine whether that data element is within a scope of a particular policy. For example, in the network management domain, a network path calculation can be performed to determine which network elements are within the scope of devices supporting a particular application.

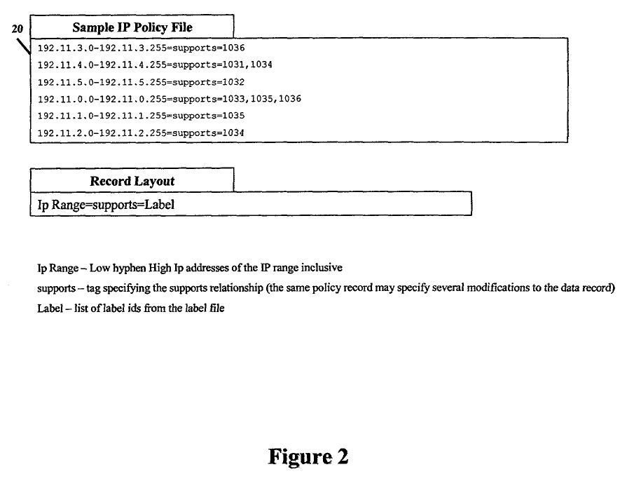

By way of example, FIG. 2 depicts a sample policy file 20 containing an illustrative policy defined in accord with the teachings of the invention in the network management domain. This policy defines a set of ranges of IP (internet protocol) addresses, and further provides an association between each IP address range and the identification field of a label to be defined.

Referring again to FIG. 1, in step 14, a plurality of labels are generated based on the defined policy. The labels are utilized to mark, e.g., tag, the data set. Each label has a scope that is defined by the policy. The scope of a label, as used herein, refers to the data, e.g., the data files, that are accessible to that label. In other words, those data files that have been designated to be associated with a particular label are considered as belonging to, or forming, the scope of that label.

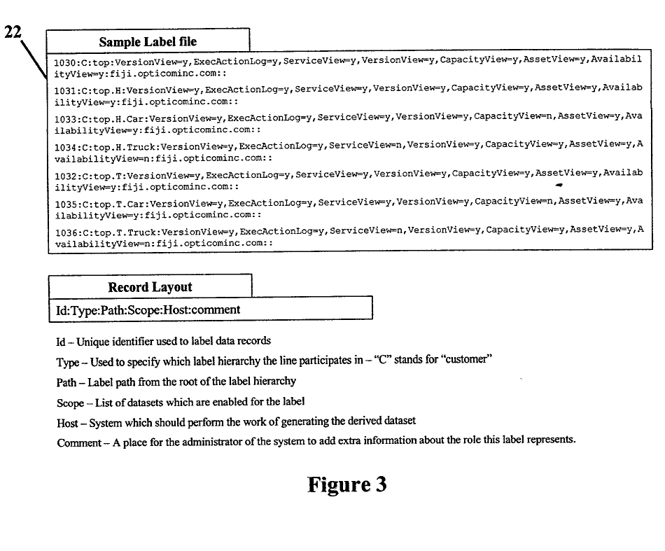

FIG. 3 illustrates a sample label file 22 created in accord with the teachings of the invention based on a pre-defined policy. The sample label file 22 includes a plurality of labels, each of which is identified by an identification (Id) number (in a range of 1030 to 1036). Each label has a scope, i.e., a list of data files enabled for that label, that is determined by parsing a policy file, e.g., the sample policy file 20. For example, the sample policy file 20 indicates that the scope of a label having an identification number 1036 includes data relating to IP addresses ranging from 192.11.3.0 to 192.11.3.255 and also ranging from 192.11.0.0 to 192.11.0.255. Thus, data corresponding to entities, e.g., devices, having IP addresses in these two ranges forms the scope of a label having the Id number 1036.

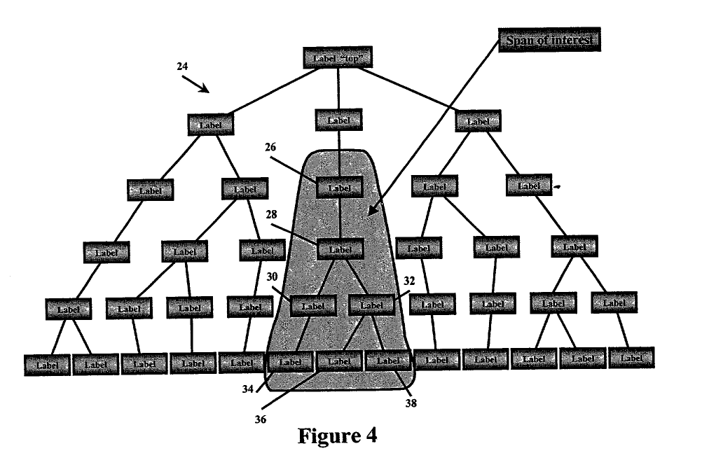

The labels generated by a method of the invention can be interrelated according to a selected topology. Such a topology can be, for example, a distributed configuration, or it can form a hierarchy, such as a tree structure. For example, FIG. 4 illustrates a label hierarchy 24 created in accord with the teachings of the invention which includes a root label, herein designated as Label “top”, from which a plurality of labels emanate. The inclusion of the label “top” ensures that the complete dataset is available for presentation. Each label has a selected data scope determined by at least one policy, as described above.

Referring again to FIG. 3, the sample label file 22 presents an example of a label hierarchy. In particular, the label 1030 is the root label that spawns the other labels. Further, labels H.Car and H.Truck are both derived from the label H (designating an automobile manufacturing company), and labels T.Car and T.Truck are both derived from the label T (designating another automobile manufacturing company). Although the labels T and H belong to two different branches of the label tree, they may nevertheless share some common data files within their respective scopes. For example, label file 22 in FIG. 3 shows that some data files, e.g., VersionView, ExecActionLog, as accessible to both H and T labels.

Referring again to FIG. 4, a union of a plurality of selected labels, i.e., a union of the data scopes of selected labels, provides a span of interest. In this example, a union of the data associated with labels 26-38 forms the span of interest.

In general, a user is allowed to access information organized in accord with the teachings of the invention based on a set of pre-defined privileges granted thereto. In particular, a role assigned to a user determines the data within the scope of one or more labels that are available to the user. When the labels form a hierarchy, the role of the user determines its entry point into that hierarchy. In some embodiments of the invention, a user who can enter a label hierarchy at a principal label can also access data within the scopes of labels below the principal label. For example, with reference to FIG. 4, if a user has permission to enter the label hierarchy 24 at the label 26, it also has permission to enter the label hierarchy at label 28. This allows a user to assume different roles and view the information from different perspectives.

In addition, some embodiments of the invention provide a second level of permission that specifies the data files within the scope of a label that a user can access. For example, a user whose role allows it to access the label 28 may not have permission to view every data file within the scope of this label. Rather, such a user may have access to a subset of the data within the scope of the label 28.

System administrators typically have special privileges. These privileges may include, for example, the privilege to create other users and to define policies which determine the scope of labels. The privileges of an administrator may also be scoped by a role hierarchy. For example, an administrator may be able to provide a user with privileges which are similar to or less than those of the administrator, but may not be able to allow a user to assume more roles than the administrator itself can assume.

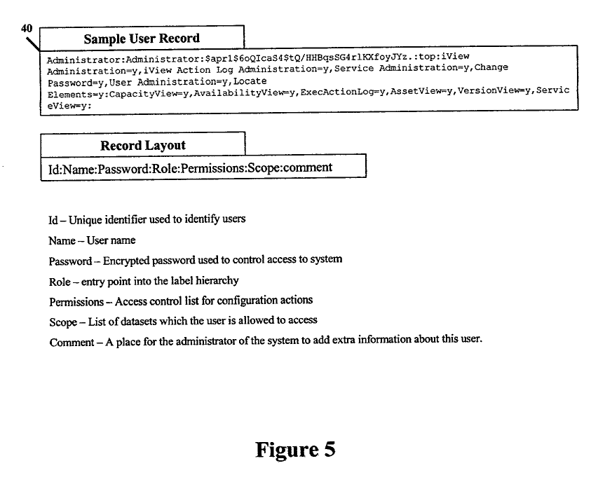

In some embodiments, the information regarding the privileges granted to a user is stored in a user access list. FIG. 5 illustrates an exemplary user access list 40 that includes an Id field containing a unique identifier for identifying a user, a Name field that includes the name of the user, a Password field that controls access to the database, and a Role field that indicates the entry point at which the user can access a label hierarchy. The exemplary user access list 40 also provides information regarding permissions granted to a user, including the scope of datasets that the user is allowed to access.

In a label hierarchy, the data scope of one label may be independent from that of another label. Further, the data scope of a label can be independent of the label hierarchy. For example, with reference to FIG. 4, although label 28 is further down in the hierarchical tree structure than label 26, it may have a larger scope than that of label 28. That is, label 28 can provide access to a larger set of data files than label 26. The advantages provided by such a decoupling of the label scope from label hierarchy can be perhaps better understood by considering an example. A user whose principal entry point into the label hierarchy is the label 28 may be the manager of a division of an automobile manufacturing company. Hence, the data scope of label 28 is commensurate with the informational needs of the division manager. For example, the division manager may need access to information regarding the number of cars sold within a particular time span. This information can be found within the data scope of the label 28.

Another user whose principal entry point into the label hierarchy is the label 26 may be the marketing manager of this company. The marketing manager may need more detailed information regarding sales statistics than the division manager. For example, the marketing manager may need to know not only the number of cars sold within a particular time span, but also the colors of the cars sold. Thus, the data scope of the label 28, i.e., the data to which label 28 has access, may be more extensive than that of the label 26. That is, although the label 28 is lower in the hierarchical tree than the label 26, it nevertheless provides access to a more extensive set of data files than the label 26. The division manager, however, can assume the role of the marketing manager, if needed, to enter the label hierarchy at label 28 to obtain access to more detailed information regarding sales.

Referring again to the flow chart 10 of FIG. 1, subsequent to generating labels, the data scope associated with a selected label can be transformed, in step 16, to create a derived data set which is suitable for the informational needs of a user having access to that label. For example, with reference to the sample label file 22 of FIG. 3, such a transformation can be utilized to derive information about the number of cars sold during a particular time span from the data contained within the scope of the label H.Car. The transformation preferably preserves the association of the derived data set with the label from which the derived data set is obtained. For example, in this case, the derived data set containing information regarding the number of cars sold remains within the scope of the label H.Car.

A number of different transformations, also referred to herein as shaping transformations, can be performed on the data within the scope of a label to create a variety of derived data sets. Further, a variety of algorithms and calculations can be utilized to implement such transformations so long as they preserve any scoping labels which appear in the data records. A simple type of transformation is summarizing a particular data set along a selected dimension, e.g., geography, time. For example, a temporal transformation can summarize the data over a specified time period, e.g., number of switch failures in a telecommunications system over a period of a month obtained by summarizing the daily data regarding such failures.

The method of the invention further allows presenting the derived data set to a user in any format that is preferable to that user. In particular, with reference to FIG. 1, in step 18, the derived dataset is formatted to a format needed by a selected presentation engine. The presentation formats that can be utilized for formatting the derived data set can include, but are not limited to, HTML, XML, PDF, RDBMS, and CSV.

The method of the invention for organizing data in a database provides distinct advantages. In particular, employing a labeling scheme based on a pre-defined policy in conjunction with shaping transformations provides a flexible information system that can be readily tailored to the needs of various organizations. Further, providing a hierarchical role tree through which users can be granted access to multiple scopes of data ameliorates the administrative burden of aligning an individual user's view of the information with the user's responsibilities within the organization. Further, the use of record labeling to indicate data scope, and ensuring that shaping transformations preserve such a labeling scheme, allow providing a customizable information system with minimal complexity.

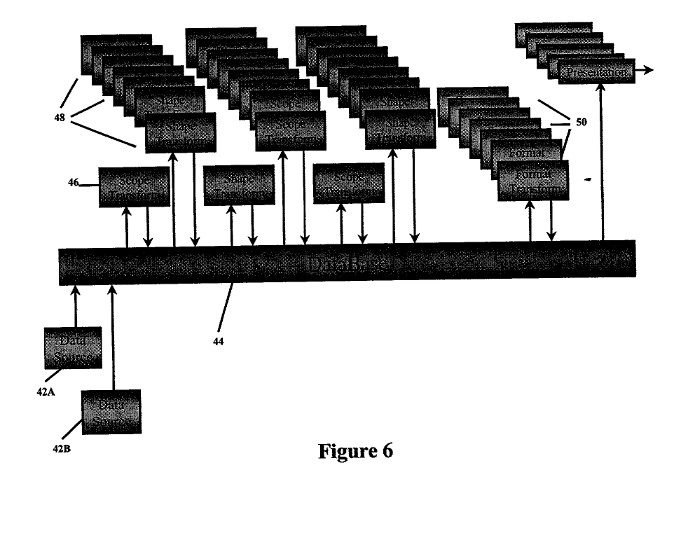

The methods and system of the invention can be utilized in a variety of different applications. For example, in the network management domain, methods and system according to the invention can be utilized to organize data corresponding to performance of a network. With reference to FIG. 6, a variety of data sources, such as sources 42A and 42B, populate a database 44 with raw data corresponding to network related data which can include, e.g., device information such as name, location, IP address, configuration settings, fault settings, performance parameters, security parameters, bandwidth. Other network related information can include, e.g., topology mapping data, system capacity data, server discovery data, etc.

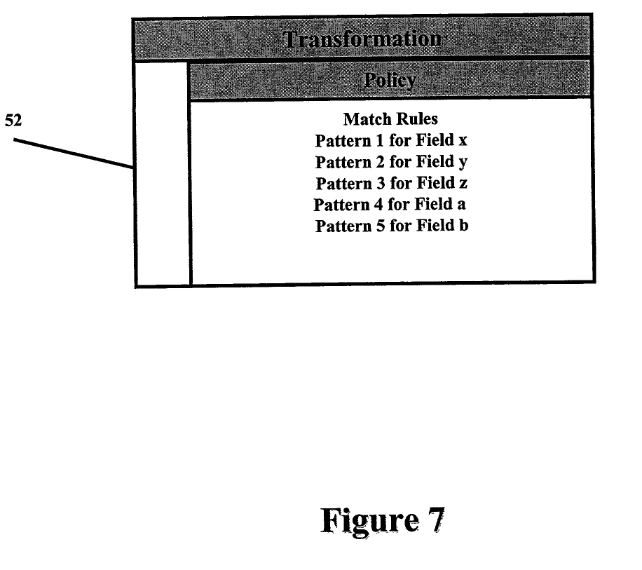

A scoping transformation 46, based on a pre-defined policy, is performed on the raw data to label the data in a manner described above. As shown in FIG. 7, a policy can be based on matching pre-defined patterns with selected fields of the data. In a network-related policy, a defined pattern can be, for example, a range of IP addresses of network devices, e.g., routers, or alternatively, it can be devices which are located within a particular geographical range.

As discussed above, a user can access the data within the scope of one or more labels based on its pre-defined roles. Referring again to FIG. 6, a variety of shaping transformations can be performed on the data within the scope of a label to which the user has access to create derived data sets that are suited to the different informational needs of that user. That is, a derived data set includes “customized” data for a particular need of a user. Such a derived data set can include, for example, a summary of data regarding traffic congestion and performance data for network devices having IP addresses that lie within a specified range. In addition, the shaping transformation can include statistical analysis, filtering, or any other manipulation of the data that renders it suitable for the needs of a user.

Multiple iterations of scoping and shaping transformations can be performed on a set of data. That is, a derived dataset generated by a shaping transformation can be utilized as an input for another shaping transformation or another scoping transformation. Further, a variety of formatting transformations 50 can be applied to the transformed data to prepare it for presentation via selected presentation engines.

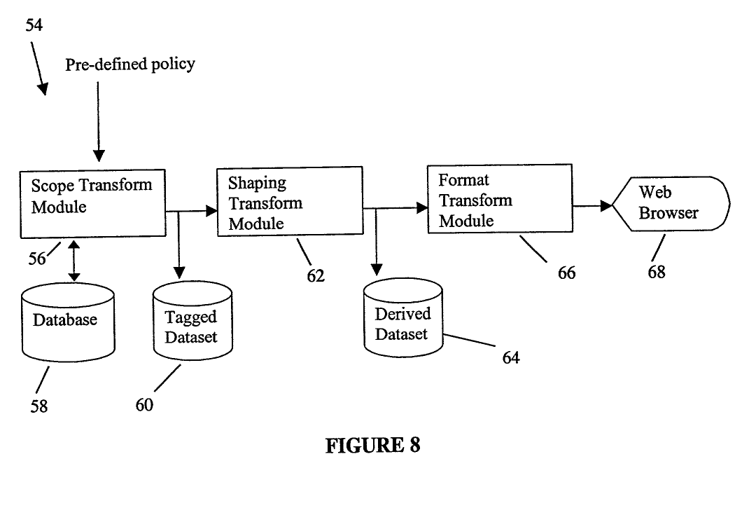

FIG. 8 is a diagram that schematically depicts an exemplary system 54 for implementing a method for organizing data in a database in accord with the teachings of the invention. The exemplary system 54 includes a scope transform module 56 that is in communication with a database 58 which stores raw data. The scope transform module 56 generates labels based on a pre-defined policy to mark, i.e., tag, at least a portion of the raw data to create a tagged dataset 60.

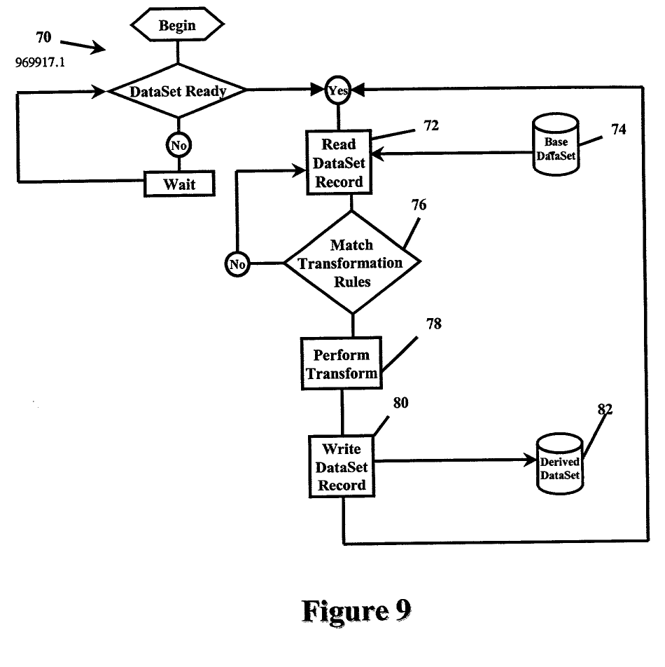

A shaping transform module 62 receives the tagged data and generates a derived dataset 64 therefrom. FIG. 9 provides a flow chart 70 that schematically illustrates the operation of the exemplary transform module 62 of FIG. 8. In particular, in step 72, data is read, for example, record by record from a dataset 74. In step 76, a comparison is made between the data and a set of pre-defined transformation rules. If the comparison indicates that a match exists, i.e., the data needs to be transformed, the transformation process continues, as described below. Otherwise, another data record is read and the comparison step 76 is repeated. In step 78, a transformation is performed on those records that match the pre-defined transformation rules. In step 80, the output of the transformation is written to a derived dataset 82. It is this derived dataset 82 that is then formatted and eventually presented to an authorized user.

Referring again to FIG. 8, the exemplary system 54 further includes a format transform module 66 that can apply one or more formatting transformations to the derived data set to augment it with requisite information for presentation to a user. A number of presentation engines can be utilized to present the formatted information to a user. In this example, a web browser 68 presents the data in a web format, e.g., HTML, to a user.

The various modules of a system of the invention can be created by utilizing well-known software design and implementation practices. Various programming languages, such as C++, Java, or other object-oriented or structured languages, can be utilized for generating software modules corresponding to the modules described above. In addition, a system of the invention can have a distributed architecture in which various modules interact with one another and the data repositories, i.e., databases, via a network, e.g., the Internet.

The above embodiments are presented for illustrative purposes only. Those skilled in the art will appreciate that various modifications can be made to these embodiments without departing from the scope of the present invention. For example, policies other than those described in the above examples can be defined and implemented by a system of the invention. Further, the formatting transformations are not limited to those described above.

What is claimed is:

1. In a database system, a method for organizing information in a dataset, the method comprising the steps of:
defining a set of rules that establish a policy, and
generating at least one label based on said defined policy for tagging said dataset,
wherein said policy determines a data scope accessible to said label.

2. The method of claim 1, wherein said policy is based on a structure of an organization.

3. The method of claim 1, wherein said policy is based on geography.

4. The method of claim 1, wherein said policy is based on location of selected entities.

5. The method of claim 1, wherein said policy is based on names of selected entities.

6. The method of claim 1, wherein said policy is based on interrelationships of selected entities.

7. The method of claim 1, wherein said policy defines a range of IP addresses for a plurality of devices.

8. The method of claim 1, wherein said dataset includes a plurality of fields and said rules are defined as expressions operating on selected fields of said dataset.

9. The method of claim 8, wherein said expressions are Boolean expressions.

10. The method of claim 8, wherein said expressions are regular expressions.

11. The method of claim 8, wherein the policy includes matching a selected pattern with fields of the dataset.

12. The method of claim 1, wherein said step of generating further includes creating a plurality of labels interrelated by a selected topology.

13. The method of claim 1, wherein said topology is selected to be a distributed configuration.

14. The method of claim 1, wherein said step of generating further includes creating a plurality of labels forming a hierarchy.

15. The method of claim 14, wherein said hierarchy has a tree structure.

16. The method of claim 14, wherein each of said labels provides an entry point into said hierarchy.

17. The method of claim 1, wherein said dataset includes a plurality of fields and said generating step includes tagging at least one field of said dataset with a label indicating association of said field with at least one scope determined by said policy.

18. The method of claim 16, wherein a role of a user of said database system determines an entry point for said user into said hierarchy.

19. The method of claim 1, wherein at least a portion of data within the scope of said label is accessible to a user based on the user's pre-defined role and permission granted to said user.

20. The method of claim 13, wherein the data scope of each label is independent of the data scope of another label.

21. The method of claim 14, wherein said label in said hierarchy contains datasets that are independent of the hierarchy and are related to a role of a user.

22. The method of claim 1, further comprising the step of transforming said data scope based on a role of a user to provide a derived data set suitable for informational needs of the user.

23. The method of claim 22, wherein said step of transforming preserves association of the derived dataset with said label.

24. The method of claim 1, further comprising the step of generating a role access list containing information regarding at least a role that a user of said database system can assume, wherein said role determines whether said user has access to the data scope associated with said label.

25. The method of claim 24, further comprising the step of allowing a user to assume different roles.

26. The method of claim 22, wherein said transforming step includes a temporal transformation that aggregates selected fields within said data scope over a specified time period.

27. The method of claim 22, further comprising the step of formatting said derived data set to augment said derived data set with information needed for a selected presentation format.

28. The method of claim 27, wherein said presentation format is selected from the group consisting of HTML, XMNL, CSV, RDBMS and PDF.

29. The method of claim 1, wherein said policy is defined by an administrator of said system.

30. In a network management system, a method for processing raw data, comprising the steps of:
scoping said raw data by extracting a plurality of subsets of said raw data to create a data span based on a pre-defined policy, and
shaping said data span to create a derived data set in accord with a role of a specific user.

31. The method of claim 30, wherein said spanning policy is defined by an administrator of said network management system.

32. The method of claim 30, further comprising the step of formatting said derived data set to augment said derived data set with information needed for a selected presentation format.

33. The method of claim 32, wherein said presentation format is selected from a group consisting of HTML, XML, CSV, RDBMS and PDF.

34. The method of claim 30, wherein said rules are defined to scope said raw data based on a structure of an organization utilizing said network management system.

35. The method of claim 30, wherein said rules scope said raw data based on interrelationships of selected entities.

36. The method of claim 35, wherein said interrelationships form a hierarchy.

37. The method of claim 30, wherein said shaping step is selected to include a temporal transformation that aggregates said plurality of subsets over a specified time period.

38. The method of claim 30, wherein said policy rules are defined such that said scoping step creates a data span including a structural interrelationship of at least partially overlapping subsets of data.

39. The method of claim 30, further comprising the step of allowing a user of said network management system to assume different roles.

40. The method of claim 30, wherein said scoping step includes tagging fields of said raw data with labels indicating association of each field with at least one scope defined by said policy.

41. A system for organizing data in a database, comprising:
a scope transform module in communication with a database, said scope transform module receiving raw data from said database and labeling at least a portion of said raw data based on a pre-defined policy, and
a shaping transform module receiving said labeled data and transforming at least a portion of said labeled data to a derived dataset that conforms to informational needs of a user.

42. The system of claim 41, further comprising
a format transform module that receives the derived dataset and augments the derived dataset with information needed for a selected presentation format.

43. The system of claim 42, wherein said presentation format is selected from the group consisting of HTML, XML, PDF, CSV, and RDBMS.

44. The system of claim 42, further comprising a presentation engine for presenting said formatted dataset to a user.

45. The system of claim 42, wherein said presentation engine is a web browser.
